(19) United States
(12) Patent Application Publication
(10) Pub. No.: US 2002/0194946 A1
(43) Pub. Date: Dec. 26, 2002

(54) Steering wheel cover having a storage pocket

(76) Inventor: Crystal Jackson, Charlotte, NC (US)

Correspondence Address: David L. Banner, PO Box 2607, Fairfax, VA, 22031, US

(21) Appl. No.: 09/886,220

(22) Filed: Jun. 22, 2001

(51) Int. Cl. B62D 1/06

(52) U.S. Cl. 74/558

(57) ABSTRACT

The present invention features a cover for completely surrounding the steering wheel of a vehicle to protect the steering wheel from the effects of sun and heat. The cover is made from fabric or a fabric-like material such as vinyl and has an elastic band in the perimeter of a central opening in the rear of the cover which may be stretched to facilitate placing the cover over and around the steering while holding the cover securely in place when the elastic is in a relaxed state. Indicia, either a decoration or an advertisement may be placed of the front face of the cover. In addition, one or more pockets or compartments are provided on the front face to securely hold sunglasses or similar items while the steering wheel cover is in place. An optional lifting loop may be added to facilitate removal of the cover from the steering wheel.

### BACKGROUND OF THE INVENTION

1. Field of the Invention

The present invention relates to a steering wheel cover and, more particularly, to a protective cover for placing over a steering wheel to protect the steering wheel from sun, heat, etc. A storage pocket for sunglasses or the like is provided on the face of the cover which may also carry indicia.

It is well known that the interior of a car, truck, boat or other similar vehicle becomes warm when the vehicle is left tightly or even partially closed and exposed to the sun during warm seasons of the year. In extreme cases, direct sun beating down on the vehicle's steering wheel can heat the steering wheel to a temperature where plasticiser components may be driven from the polymeric material from which most steering wheels are manufactured. This may embrittle the polymeric material which can lead to premature material failure. This may be problematic, particularity if the vehicle is involved in a collision. Even if temperatures do not reach a level capable of causing structural changes and/or damage to the steering wheel, the wheel may become so warm as to be unsafe or uncomfortable to touch by the driver returning to the closed vehicle. Several solutions to this problem have been proposed in the prior art as discussed hereinbelow. None of the approaches taken heretofore to solve this problem are seen to provide the features and functionality of the steering wheel cover of the present invention.

2. Description of the Prior Art

U.S. Pat. No. 4,102,377 for STEERING WHEEL COVER DEVICE, issued Jul. 25, 1978 to Nels M. Ostrem, teaches a protective, foam lined envelope which may be slipped over the top of a steering wheel. The OSTREM device has a semi-circular top and a rectangular bottom. The design is such that the lower rear portion of the steering wheel remains exposed to sun and heat, even with the OSTREM cover in place.

In contradistinction, the inventive steering wheel cover completely surrounds the steering wheel and is held in place by elastic, or the like, in the cover's perimeter of an opening in the rear side of the cover. The inventive cover works easily, without adjustment, with a wide variety of steering wheel sizes. A solid, circular face is presented to the driver of the vehicle when the steering cover is in place on the steering wheel. One or more pockets suitable for storing sunglasses or the like are provided on the face. In addition, indicia, for example a decorative design or advertising, may be displayed on the exposed face of the inventive cover.

U.S. Pat. No. 4,287,621 for STEERING WHEEL ATTACHMENT, issued Sep. 8, 1991 to Charles A. Kertz teaches a structure designed to attach to the steering wheel of a vehicle. KERTZ teaches a semicircular structure having a rear pocket allowing the cover to be slipped over the steering wheel. A zipper along a bottom edge of the KERTZ cover allows access to an interior region thereof. The KERTZ cover has a thick, padded region at the front surface which functions as a pillow and is designed to provide comfort to a person who may choose to rest their head against the vehicle's steering wheel on the cover/pillow. There is no specific steering wheel protection function taught by KERTZ.

The steering wheel cover of the present invention is, on the other hand, completely circular and totally surrounds the steering wheel thereby protecting the bottom of the wheel as well as the top from sun rays or the like. The inventive cover provides no pillow function and has no zipper access to an interior region of the cover. The cover of the present invention does, however, have a pocket for holding sunglasses or the like disposed on the front surface of the circular cover.

U.S. Pat. No. 4,685,499 for STEERING WHEEL COVER, issued Aug. 11, 1987 to Todd W. Black teaches a steering wheel cover made from rectangular flat stock. The BLACK cover resembles a pizza box with a notched cutout in the rear panel to accommodate (i.e., slide over) the steering column. The structure, which is open along a bottom edge, is slipped over the steering wheel. When not in use, the BLACK cover is collapsible (i.e., flattenable) to facilitate storage. Indicia may be placed on the front surface (i.e., the surface facing the driver). BLACK also suggest that frangible, removable sections may be placed in the front surface to serve as coupons or the like.

The steering wheel cover of the present invention is conformable to the steering wheel and generally made from a flexible material such as plastic or cloth. There is no need for foldable side seems because the inventive design readily collapses and may be folded, rolled, wadded, or otherwise compacted for storage when not in use. There is no provision in the inventive design for a removable coupon imbedded in or placed on the front surface of the steering wheel cover. No pocket for storing sunglasses or the like is shown on the front face of the BLACK cover.

U.S. Pat. No. 5,131,290 for STEERING WHEEL COVER, issued Jul. 21, 1992 to Chad Atkinson discloses a steering wheel cover for placing around the steering wheel and a portion of the steering column of a vehicle. ATKINSON shows a decorative design or advertising on the front face but fails to show a pocket for storing sunglasses or the like. An adjustable length cord is provided by ATKINSON to adapt the cover to a range of different steering wheel sizes.

The steering wheel cover of the present invention, on the other hand, uses an elastic band at the perimeter of the opening in the rear side of the cover to allow adjustment-free use of the cover on a wide range of steering wheel sizes. In addition, the cover of the present invention has one or more pockets on the front face to accommodate sunglasses or similar items while the steering wheel cover is in place.

U.S. Pat. No. 5,507,205 for HAT SHAPED BACK PACK STEERING WHEEL COVER, issued Apr. 16, 1996 to Avi Ruimi teaches a steering wheel cover having an inner compartment adapted for storing and carrying items. The RUIMI apparatus is adapted to be worn either as a hat or, using straps which are attached to the apparatus, as a back pack. No indicia is shown on a front face. Neither is there provided any external storage on the front face for such items as sunglasses. Items stored within the RUIMI device are inaccessible when the apparatus is in place over a steering wheel. The RUIMI apparatus must be secured to the steering wheel and/or steering column with straps.

The steering wheel cover of the present invention uses an elastic band at the perimeter of a hole in the rear surface of the cover to facilitate easy installation and removal of the steering wheel cover. In addition, one or more pockets or other such storage devices are provided on the front face.

None of the above inventions and patents, taken either singly or in combination, is, however, seen to anticipate or suggest the instant invention as claimed.

### SUMMARY OF THE INVENTION

The present invention relates to a cover for completely surrounding the steering wheel of a vehicle to protect the steering wheel from the effects of sun and heat. The cover is made from fabric or a fabric-like material such as vinyl and has an elastic band at the perimeter of a central hole in the rear surface of the cover which may be stretched to facilitate placing the cover over and around a steering wheel while holding the cover securely in place when the elastic is in a relaxed state. Indicia, either a decoration or an advertisement may be placed of the front face of the cover. In addition, one or more pockets or compartments are provided on the front face to securely hold sunglasses or similar items while the steering wheel cover is in place.

Accordingly, it is a principal object of the invention to provide a steering wheel cover completely surrounding the steering wheel of a vehicle.

It is another object of the invention to provide a steering wheel cover which may be used with a variety of different sized steering wheels.

It is a further object of the invention to provide a steering wheel cover which may be easily installed and removed from the steering wheel.

Still another object of the invention is to provide a steering wheel cover which may carry indicia on a front face of the cover.

An additional object of the invention is to provide a steering wheel cover wherein the indicia is either a decoration or an advertisement.

It is again an object of the invention to provide a steering wheel cover having at least one pocket or compartment on the front face of the cover for storing eyeglasses or other similar items in a safe, secure manner.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is front, plan view of the steering wheel cover of the invention;

FIG. 2 is a rear, plan view of the steering wheel cover shown in FIG. 1;

FIG. 3 is schematic perspective view of the steering wheel cover of the invention in place over the steering wheel of a vehicle; and

FIG. 4 is a top, cross-sectional view of an alternate embodiment of the steering wheel cover having an additional insulating layer.

### DETAILED DESCRIPTION OF THE PREFERRED EMBODIMENTS

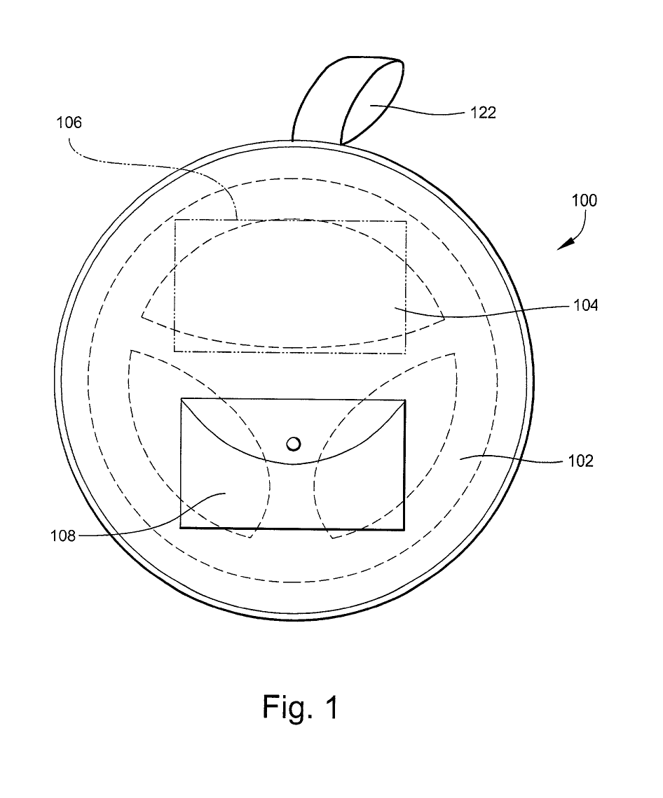

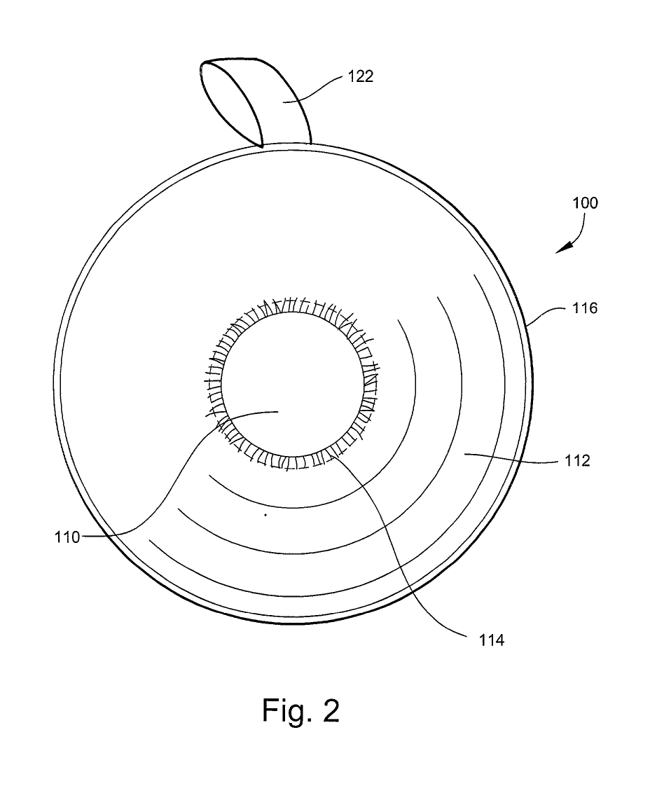

The present invention relates to steering wheel covers and, more particularly to a steering wheel cover for a vehicle which is designed to protect the steering wheel from the effects of sun and heat. Referring first to FIG. 1, there is shown a front, plan view of the inventive steering wheel cover, generally at reference number 100. Cover 100 is manufactured from thin sheet material such as fabric or plastic. Typical materials include cotton or polyester fabric, vinyl, or other similar polymer or composite material such as are well known in the art. A steering wheel 102, shown in phantom, is surrounded by the steering wheel cover 100. Steering wheel 102 may be associated with a car, truck, boat, construction machine, or any other vehicle or equipment which is equipped with such a wheel. For purposes of disclosure, cover 100 is shown substantially circular. It should be obvious that oval or other shapes could be chosen to accommodate a particular operating circumstance or environment. A front face 104 is shown completely covering the area bounded by the rim of steering wheel 102. A region 106 on front face 104 may contain indicia which may be a decorative design, text such as installation and/or removal instructions, an advertisement, or any other graphical and/or textual message as may be conceived. The content of indicia region 106 forms no part of the present invention. It will be obvious that indicia region may be placed anywhere on front face 104 or, in alternate embodiments, may consist of multiple, smaller regions distributed about front face 104, each bearing indicia. For example, multiple small adds (not shown) could be placed around the periphery of front face 104. Indicia could also be placed on the outside surface of rear member 112 (FIG. 2), either exclusively or in addition to indica placed on front member 104. Also attached to front face 104 is a pocket 108. Pocket 108 may be sized and adapted for holding one or more pairs of glasses or other similar items. Placing pocket 108 on the front face of steering wheel cover 102 affords protection for the eyeglasses while the operator of the vehicle is away. This avoids situations such as when glasses are left on the seat of a vehicle and a person returning to the vehicle inadvertently sits down of the glasses breaking or deforming them. It will be obvious that the internal geometry of pocket 108 may be configured to hold a particular item. It should also be obvious that multiple pockets (not shown) could also be attached to the front face 104 of steering wheel cover 100. In still other embodiments, one or more pockets 108 could be removably attached to front surface 104 using hook and loop, magnetic, or other such fastening devices. This allows objects and their containers to be fastened and unfastened to steering wheel cover 100 as desired. An embodiment where substantially all of face 104 is covered with hook and loop fastener material could be provided to accommodate a large number of pockets or compartments and allow selective positioning of pockets and/or compartments.

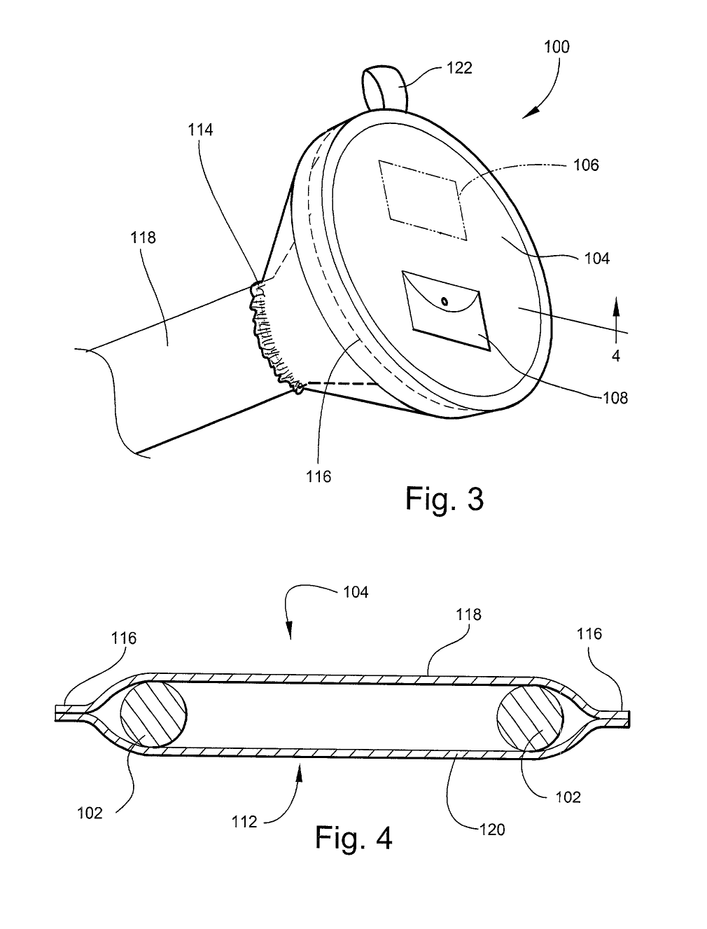

Referring now also to FIG. 2, there is shown a rear plan view of the steering wheel cover of FIG. 1. A central opening 110 is disposed in rear face 112. An elastic band 114 is placed around the periphery of central opening 110. Elastic band 114 may be attached to rear face 112 in a variety of ways. If cover 100 is constructed from fabric, elastic band 114 could be sewn into a seam as is well known in the art. If vinyl or other plastic is used, elastic band 114 could be cemented or ultrasonically welded into a seam. Other methods for attaching elastic band 114 such as are well know to those of skill in the art could also be used. Rear surface 112 is joined to front surface 104 at a peripheral seam 116. Seam 116 could formed by stitching, cementing, heat forming, ultrasonic welding or any method suitable for use with the chosen material. It is also possible to form steering wheel cover 100 from a single sheet of material by thermal forming or another suitable technique well know to those skilled in the art. Elastic band 114 allows central opening 110, shown in a relaxed state in FIG. 2, to be expanded whereby the cover 110 may be placed over a steering wheel 102. Once in place, elastic band 114 relaxes thereby snugging an inner surface of the front face 104 and/or rear face 112 against steering wheel 102 and/or steering column 118 (FIG. 3) thereby holding steering wheel cover 100 in place.

Referring now to FIG. 3, the steering wheel cover 100 is shown installed over a steering wheel 102 (FIG. 1) in a typical operational position. Elastic band 114 is snugged around steering column 118.

Several optional enhancements to the basic steering wheel cover 100 as disclosed could be added. Referring now to FIG. 4, there is shown a top, cross-sectional view of cover 100 with an added optional insulating lining 118, 120 attached to an inside surface of front member 104 and rear member 112, respectively. Lining 118, 120 is made from foam or other such insulating material and may be added to the inner surfaces of either the front and/or rear members 104, 112, respectively. The lining could provide superior insulating properties to the steering wheel cover 100 of the present invention.

In another alternate embodiment, a lifting loop or handle 122 as shown in FIGS. 1, 2 and 3 could be added near the top of cover 100 to facilitate removing cover 100 from steering wheel 102. Lifting hook 122 could be a fabric loop stitched to the cover 100 or could be a metallic or polymeric ring attached to cover 100 near its upper extremity.

In still another alternate embodiment, a heat reflecting surface could be added to one or both front at rear surfaces of the steering wheel cover.

It is to be understood that the present invention is not limited to the embodiments described above, but encompasses any and all embodiments within the scope of the following claims.

What is claimed is:

1. A cover for protecting the steering wheel of a vehicle from sunlight and heat, comprising:
a) a substantially circular, substantially solid flexible front member having an outside face and an inside face;
b) a substantially circular, flexible rear member aligned concentrically with and attached to said substantially circular front member at a perimeter thereof, said rear member having a substantially circular opening disposed therein proximate a center of and substantially concentric with said rear member;
c) an elastic band adjacent the perimeter of said cental opening and affixed to said rear member; and
d) at least one pocket affixed to said outside face of said front member;
whereby said central opening in said rear member may be stretched to slip over a steering wheel and, once in place, said elastic band relaxes thereby securing said steering wheel cover in place substantially completely enclosing said steering wheel.

2. The cover for protecting the steering wheel of a vehicle from sunlight and heat as recited in claim 1, wherein said front member and said rear member comprise a thin sheet of at least one material from the group: cotton fabric, polyester fabric, vinyl, other polymeric material, a composite fabric/polymer material.

3. The cover for protecting the steering wheel of a vehicle from sunlight and heat as recited in claim 1, further comprising indicia on an outside surface of at least one of said front member and said rear member of said steering wheel cover.

4. The cover for protecting the steering wheel of a vehicle from sunlight and heat as recited in claim 3, wherein said indicia comprises at least one from the group: textual information, graphic information, and mixed textual and graphic information.

5. The cover for protecting the steering wheel of a vehicle from sunlight and heat as recited in claim 1, wherein said at least one pocket is permanently affixed to said outside face of said front member.

6. The cover for protecting the steering wheel of a vehicle from sunlight and heat as recited in claim 5, wherein said at least one pocket comprises a plurality of pockets.

7. The cover for protecting the steering wheel of a vehicle from sunlight and heat as recited in claim 1, wherein said at least one pocket is removably affixed to said outside face of said front member.

8. The cover for protecting the steering wheel of a vehicle from sunlight and heat as recited in claim 7, wherein said at least one pocket comprises a plurality of pockets.

9. The cover for protecting the steering wheel of a vehicle from sunlight and heat as recited in claim 1, wherein said front member is joined to said back member at a seam proximate their respective perimeters.

10. The cover for protecting the steering wheel of a vehicle from sunlight and heat as recited in claim 9, wherein said seam is formed by at least one of the operations: sewing, cementing, welding, and otherwise bonding.

11. The cover for protecting the steering wheel of a vehicle from sunlight and heat as recited in claim 1, wherein said elastic band is affixed to said rear member in a seam formed by at least one of the operations: sewing, cementing, welding, and otherwise bonding.

12. The cover for protecting the steering wheel of a vehicle from sunlight and heat as recited in claim 1, further comprising:
e) an insulating layer adjacent an inside surface of at least one of said front member and said rear member.

13. The cover for protecting the steering wheel of a vehicle from sunlight and heat as recited in claim 12, wherein said insulating layer comprises a foam insulation layer.

14. The cover for protecting the steering wheel of a vehicle from sunlight and heat as recited in claim 1, further comprising:
e) a lifting loop affixed proximate said seam and adapted to facilitate removal of said cover from the steering wheel.

15. The cover for protecting the steering wheel of a vehicle from sunlight and heat as recited in claim 14, wherein said lifting loop comprises one from the group: fabric loop, metallic ring and polymeric ring.

16. The cover for protecting the steering wheel of a vehicle from sunlight and heat as recited in claim 1, further comprising: a heat-resistant layer on the outer surface of at least one of said front member and said rear member.

17. A cover for protecting the steering wheel of a vehicle from sunlight and heat, comprising: a substantially circular, front member having an outside face and an inside face; a substantially circular, member aligned concentrically with and attached to said substantially circular front member by a seam at a perimeter thereof, said rear member having a substantially circular opening disposed therein proximate a center of and substantially concentric with said rear member; an elastic band adjacent the perimeter of said cental opening and affixed to said rear member; at least one pocket affixed to said outside face of said front member; and indicia on at least one of said front member and said rear member; whereby said central opening in said rear member may be stretched to slip over a steering wheel and, once in place, said elastic band relaxes thereby securing said steering wheel cover in place.
